(19) United States
(12) Patent Application Publication
(10) Pub. No.: US 2022/0063113 A1
(43) Pub. Date: Mar. 3, 2022

(54) PROTECTIVE CAP FOR A ROBOT END EFFECTOR

(71) Applicant: WaferPath, Inc., Milpitas, CA (US)

(72) Inventors: Frantisek Pavlik, Los Altos Hills, CA (US); James Thomas McCartney, III, Conroe, TX (US)

(73) Assignee: WaferPath, Inc., Milpitas, CA (US)

(21) Appl. No.: 17/395,995

(22) Filed: Aug. 6, 2021

Related U.S. Application Data
(60) Provisional application No. 63/070,400, filed on Aug. 26, 2020.

(51) Int. Cl. B25J 19/00

(52) U.S. Cl. CPC B25J 19/0075; B25J 19/021

(57) ABSTRACT

An end effector for a robot comprises a body and two arms depending from the body. Each arm includes mating features defined therein and a sensor located therein. A protective cap is coupled to each arm, each protective cap including mating features for interlocking with the mating features of the arms. The protective caps may each be coupled to the end effector by a single fastener.

### RELATED APPLICATION DATA

This application claims the benefit of U.S. Provisional Patent Application No. 63/070,400 filed Aug. 26, 2020, the contents of which are incorporated herein by reference as if explicitly set forth.

### BACKGROUND

The concepts described herein relate to the field of robotics generally and more particularly but not exclusively to wafer transfer robots used in semiconductor fabrication facilities. To ensure high fab productivity, wafer transfer robots need to transfer wafers fast but securely, to ensure fast throughput without risking damage to wafers, the value of which can be substantial.

More particularly, the concepts described herein relate to end effectors for translating wafers from one position to another. At least one known design for robotic end effectors uses a through-beam sensor where the sensor elements are arranged at a leading edge of the end effector.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a wafer transfer robot including an end effector in an example embodiment.

FIG. 2 illustrates an exploded perspective view of part of an end effector in accordance with one embodiment.

FIG. 3A illustrates a perspective view of a protective cap in accordance with one embodiment.

FIG. 3B illustrates another perspective view of the protective cap of FIG. 3A

FIG. 4 illustrates an assembled perspective view of the part of an end effector of FIG. 2.

FIG. 5A illustrates a perspective view of a protective cap in accordance with another embodiment.

FIG. 5B illustrates another perspective view of the protective cap of FIG. 5A.

### DETAILED DESCRIPTION

The mechanism disclosed herein presents an end effector that provides protection to delicate components installed on the end effector. As an example embodiment, protection for the optical elements of an installed through-beam sensor are described, although the mechanism is not limited to that use.

By including protection as described herein, the likelihood of damage to the sensor elements that may occur if the leading edge of the end effector impacts a fixed object (e.g. a process station or tool wall) is reduced. When such impacts occur, the optical components in the sensor elements may otherwise become misaligned, bent or broken, such that continued operation of the wafer transfer robot is not possible

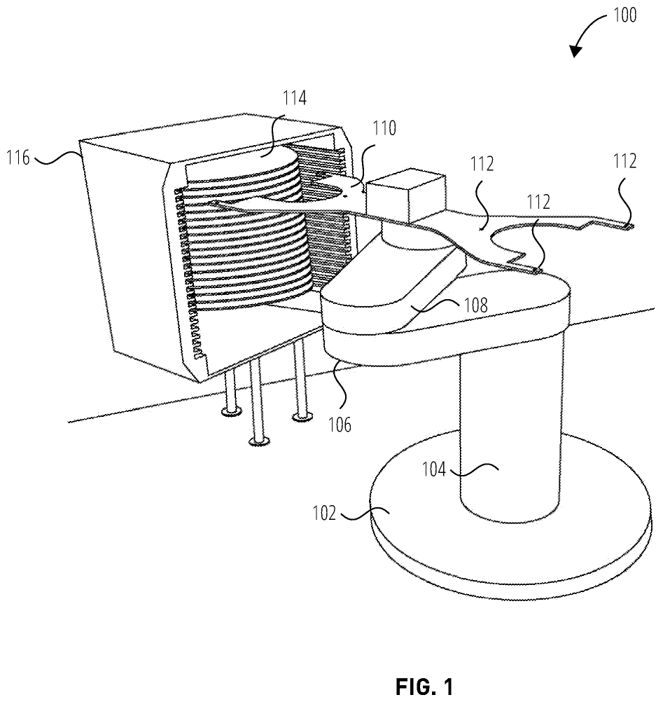

FIG. 1 illustrates a wafer transfer robot 100 according to one example embodiment. The wafer transfer robot 100 includes a base 102, a support column 104, a robot arm including one or more segments 106, 108 and an end effector 110. In some cases, the wafer transfer robot 100 may be located on a track that can be used to move the wafer transfer robot 100 back and forth between different locations. Located on the end effector 110 are one or more vacuum ports 112. The vacuum ports 112 are used to secure an item such as a wafer 114 (illustrated in a cassette 116) on top of the end effector 110. The vacuum ports 112 are coupled to a vacuum supply (not shown) via a channel underneath the end effector 110 that is in turn coupled to a vacuum supply tube that passes through the segments 106 & 108, the support column 104 and the base 102.

The support column 104 can be moved up and down and rotated about its primary axis under computer control, while segment 108 can similarly be rotated relative to segment 106 and the end effector 110 can be rotated relative to segment 108, also under computer control. In use in the situation illustrated in FIG. 1, the end effector 110 is moved underneath a wafer 114 and raised until the suction of the vacuum ports 112 engages the wafer 114, at which time the wafer can be withdrawn from the cassette 116. The wafer 114 is then transferred to another location (e.g. another cassette, a wafer prealigner, a wafer processing station etc.) by movements performed by the wafer transfer robot 100.

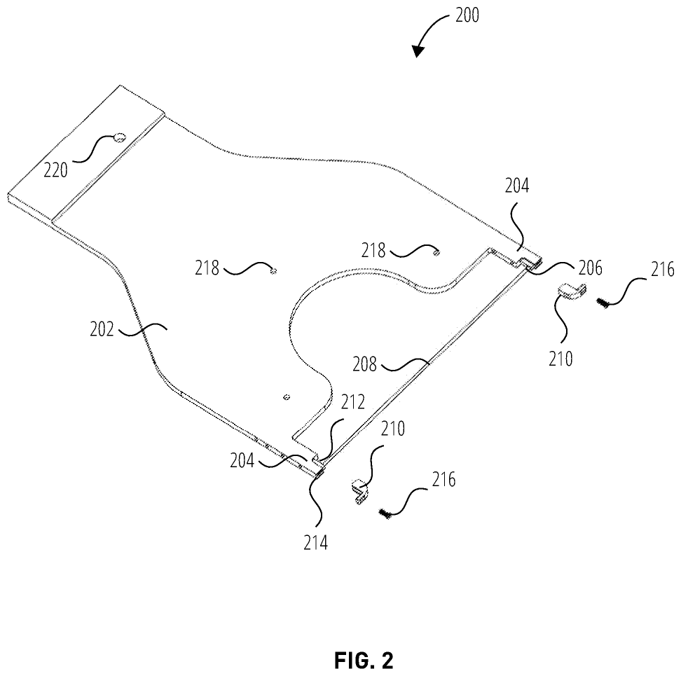

FIG. 2 illustrates an exploded perspective view of part of an end effector 200 in accordance with one embodiment. The end effector 200 comprises a body 202 and two arms 204. Each arm 204 of the end effector 200 is equipped with sensor components 206, which in the illustrated embodiment comprise a through-beam emitter and a through-beam sensor that in use provide a beam 208 that can detect the presence of a wafer 114 in the cassette 116 when the beam 208 is interrupted by the wafer 114. The end effector 200 also includes two protective caps 210 that are attached to the arms 204 by means of a fasteners 216. Additional features of a typical end effector 200 effector may also be present, for example, vacuum grip pads 218, which are connected via a channel in the end effector 200 to a vacuum line interconnect 220.

The sensor components 206 are installed in the arms 204 such that they are not exposed. In addition, a protective cap 210 is attached to each leading edge of end effector 200 to provide a protective contact surface in the event of an impact. The protective caps 210 are held in place by the fasteners 216 and interlocking surfaces between the end effector 200 and each protective cap 210. The protective caps 210 prevent or mitigate damage to the sensor components 206 because they are no longer the initial point of impact. The forces of such an impact are dissipated into the protective caps 210 and then into the surrounding material of the end effector 200. Damaging forces are thus diverted away from the sensor components 206.

Each arm 204 includes one or more surfaces that interlock with a corresponding surface on each protective cap 210. In the illustrated embodiment, each arm 204 includes a tongue 212 and a groove 214.

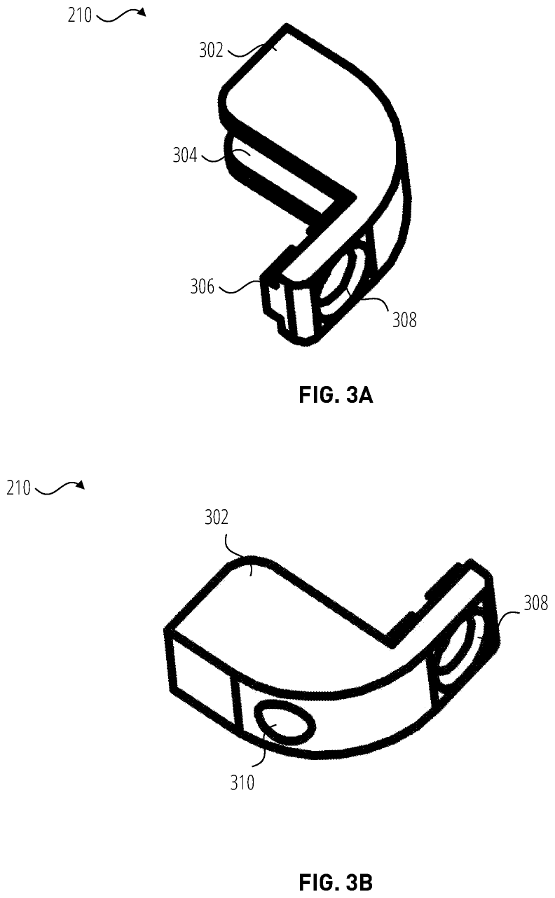

FIG. 3A illustrates a perspective view of a protective cap 210 in accordance with one embodiment. The protective cap 210 has a body 302 that has a groove 304 defined therein and a tongue 306. When assembled, the groove 304 mates with the tongue 212 of the end effector 200 and the tongue 306 mates with the groove 214 of the end effector 200. The protective cap 210 also includes a fastener hole 308 through which the fastener 216 (e.g. a threaded fastener such as a screw) is inserted to fasten the protective cap 210 to an arm 204. In this embodiment, the fastener 216 and the fastener hole 308 are parallel to the longitudinal axis of the end effector 200.

FIG. 3B illustrates another perspective view of the protective cap 210 of FIG. 3A. As can be seen from this figure, the protective cap 210 also includes a port 310 through which the beam 208 passes in use.

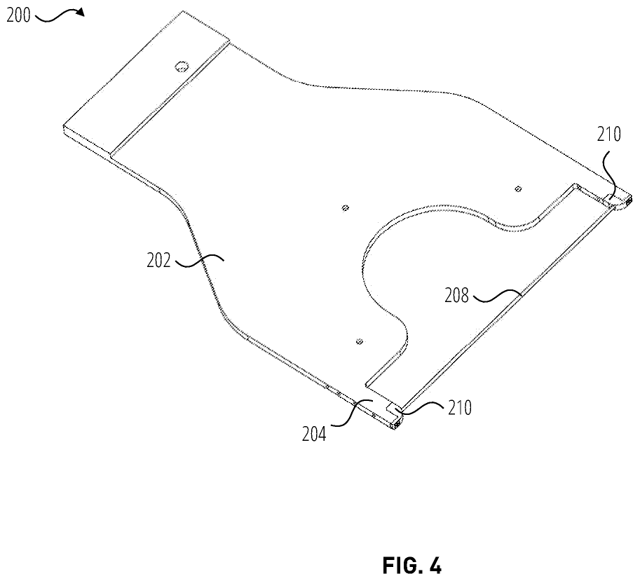

FIG. 4 illustrates an assembled perspective view of the part of the end effector of FIG. 2. As can be seen, a protective caps 210 is located in use at the end of each arm 204, covering the sensor components 206 while still allowing the beam 208 to pass between the components. It will be appreciated that an impact suffered by the arms 204 as the end effector 200 reaches away from the support column 104 of the wafer transfer robot 100 will be on the protective caps 210 and not on the sensor components 206.

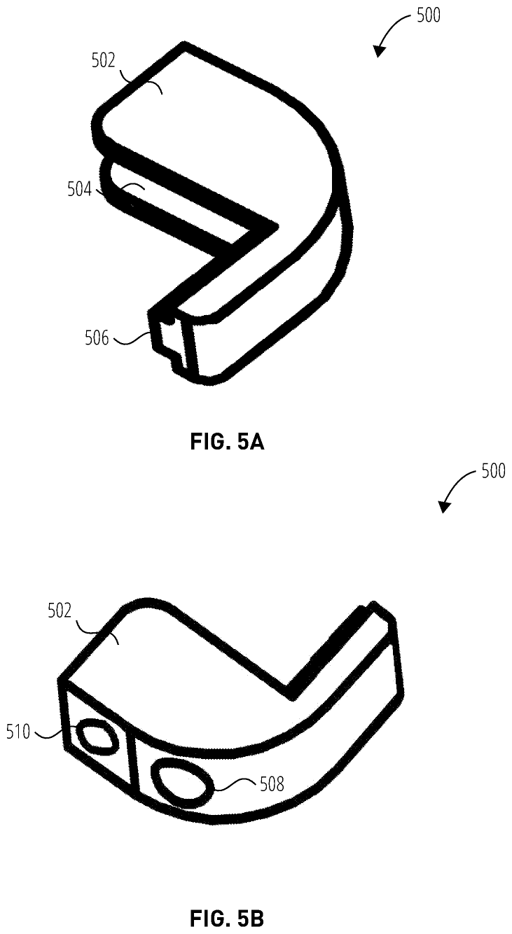

FIG. 5A illustrates a perspective view of a protective cap 500 in accordance with another embodiment. As before, the protective cap 500 has a body 502 with a groove 504 defined therein, and a tongue 506. When assembled, the groove 504 mates with the tongue 212 of the end effector 200 and the tongue 506 mates with the groove 214 of the end effector 200. As before, the protective cap 210 also includes a port 508 through which the beam 208 passes in use.

FIG. 5B illustrates another perspective view of the protective cap 500 of FIG. 5A. The protective cap 500 also includes a fastener hole 510 through which the fastener 216 is inserted to fasten the protective cap 500 to an arm 204. In this embodiment, the fastener 216 and fastener hole 510 are transverse to the longitudinal axis of the end effector 200

The configurations discussed above also addresses the constraint that the end effector 200 be as thin as reasonably possible (so that the end effector 200 can reach in between two adjacent wafers 114 without contact to either) by utilizing a single point of attachment (i.e. fastener 216.) The design also addresses the problem inherent with a single screw-like fastener, namely that two fastened parts are free to rotate around the single screw-like fastener. The end effector arms 204 and the protective caps 210 are formed such that interlocking mating surfaces prevent rotation. If forces are applied that would otherwise cause rotation, the interlocked mating surfaces generate counter opposing forces that prevent the rotation. The tongue feature designed on the mating surface of protective cap 210 and protective cap 500 also addresses problems inherent with thin parts by supplying additional thickness, strength and rigidity in addition to restricting motion.

In the example embodiments described, both the end effector 200 and protective caps may be fashioned from the same material, although this is not a requirement. Fabricating the protective caps from a dissimilar material to the end effector 200 may provide additional advantages for the design. One non-limiting example may be fabricating the protective cap from a shock absorbing material that deforms elastically under impact to reduce the potential for damage to both the end effector 200, the sensor components 206, and the object struck.

Another non-limiting example may be fabricating protective cap 210 or protective cap 500 from an ablative material, which in the event of an impact, breaks away, which causes impact forces to be converted into the forces required to break the ablative material. The remaining forces transmitted into the end effector 200 and sensor components 206 are thus reduced.

Another non-limiting example may be fabricating the protective caps from a deformable material, where the forces of impact cause a plastic deformation of the protective caps, which will divert the impact forces into the force of deformation, again reducing the forces transmitted into the end effector 200 and sensor components 206

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. An end effector for a robot, comprising:
a body;
an arm depending from the body, the arm including mating features defined therein;
a sensor located in the arm; and
a protective cap coupled to the arm, the protective cap including mating features for interlocking with the mating features of the arm.

2. The end effector of claim 1 further comprising a single fastener to couple the protective cap to the arm.

3. The end effector of claim 1 wherein the mating features of the arm and the mating features of the protective cap are tongue-and-groove features.

4. The end effector of claim 2 wherein the single fastener is parallel to a longitudinal axis of the end effector.

5. The end effector of claim 2 wherein the single fastener is perpendicular to a longitudinal axis of the end effector.

6. The end effector of claim 1 wherein the end effector and the protective cap are formed from the same material.

7. The end effector of claim 1 wherein the protective cap is formed from an ablative material.

8. The end effector of claim 1 wherein the protective cap is formed from a shock absorbing material.

9. The end effector of claim 1 wherein the protective cap is formed from a deformable material.

10. The end effector of claim 1 further comprising a second arm depending from the body, the second arm including mating features defined therein;
a sensor located in the second arm; and
a protective cap coupled to the second arm, the protective cap including mating features for interlocking with the mating features of the second arm.

11. The end effector of claim 10 wherein the sensor located in the arm and the sensor located in the second arm are an optical emitter and receiver pair that respectively transmit and receive a beam between the two arms.
